(19) United States
(12) Patent Application Publication
(10) Pub. No.: US 2010/0060401 A1
(43) Pub. Date: Mar. 11, 2010

(54) INDUCTOR AND INDUCTOR COIL

(75) Inventors: FANG-TA TAI, Tu-Cheng (TW); Chen-Hsiang Lin, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/240,972

(22) Filed: Sep. 29, 2008

(30) Foreign Application Priority Data
Sep. 9, 2008 (CN) 200810304429.4

(51) Int. Cl. H01F 27/30

(52) U.S. Cl. 336/196

(57) ABSTRACT

An inductor includes a ferromagnetic core, an inductor coil, and a holder. The inductor coil is coiled to form one or more loops around a center. The inductor coil defines a through hole surrounded by an innermost loop to fit about the ferromagnetic core. The holder is configured for holding the ferromagnetic core with the inductor coil. Two ends of the inductor coil protrude out of the holder.

### BACKGROUND

1. Field of the Invention

The present invention relates to an inductor and an inductor coil.

2. Description of Related Art

Inductors are passive electrical components widely used in electronic devices. Referring to FIG. 3, a typical inductor 10 includes a ferromagnetic core 20, an inductor coil 30, and a holder 40. The inductor coil 30 is helical shaped, and wrapped around the ferromagnetic core 20. The ferromagnetic core 20 is arranged in the holder 40. Two ends 32 of the inductor coil 30 protrude out of the holder 20 for connecting to peripheral circuits. However, the typical inductor 10 has a great length L because the inductor coil 30 is very long. Thus, the typical inductor 10 cannot satisfy the need of reducing the size of electronic devices.

What is needed is to provide an inductor that has a small length.

### BRIEF DESCRIPTION OF THE DRAWINGS

FIG. 1 is a plan, schematic view of an embodiment of an inductor having an inductor coil.

FIG. 2 is an isometric view of the inductor coil of FIG. 1.

FIG. 3 is a plan, schematic view of a typical inductor.

### DETAILED DESCRIPTION OF THE EMBODIMENTS

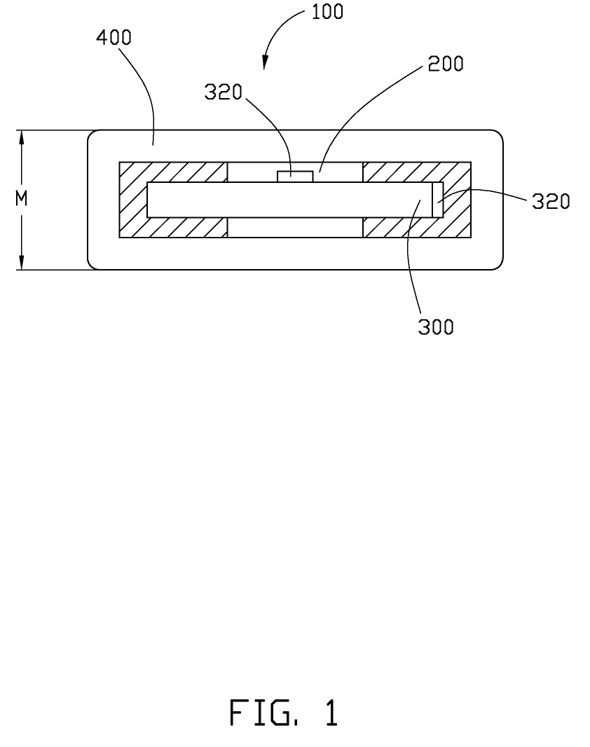

Referring to FIG. 1, an embodiment of an inductor 100 includes a ferromagnetic core 200, an inductor coil 300, and a holder 400.

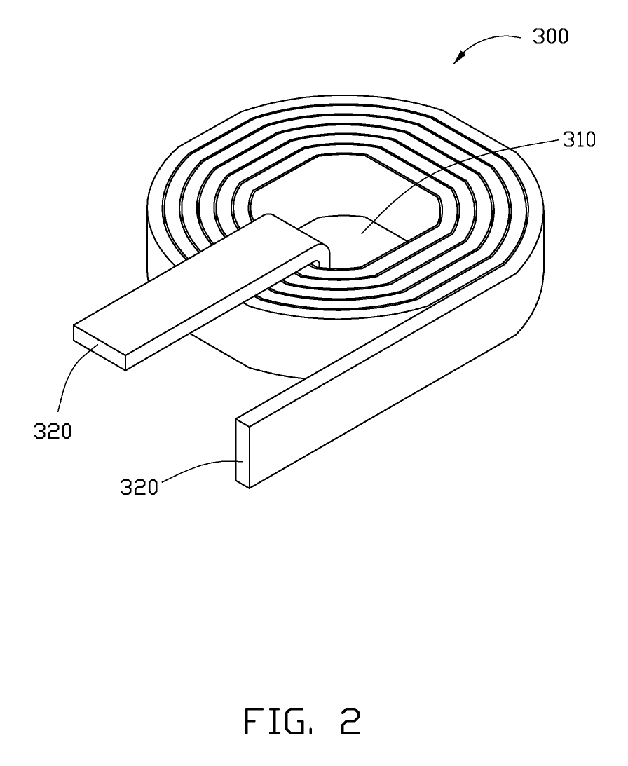

Referring to FIG. 2, the inductor coil 300 is a long flat conductor, made of a conductive material such as copper, and is coiled to form one or more loops. The inductor coil 300 may be wrapped with insulation tape. The inductor coil 300 defines a through hole 310 surrounded by an innermost loop of the one or more loops to fit about the ferromagnetic core 200. The ferromagnetic core 200 with the inductor coil 300 is arranged in the holder 400. Two ends 320 of the inductor coil 300 protrude out of the holder 400 for connecting to peripheral circuits.

Since the inductor 100 employs a long flat conductor coiled to form an annular member, the length M of the inductor 100 is small. Therefore, the inductor coil 300 can satisfy the need of reducing the size of electronic devices employing inductors.

The working theory of the inductor 100 can be explained by the following equation (1):

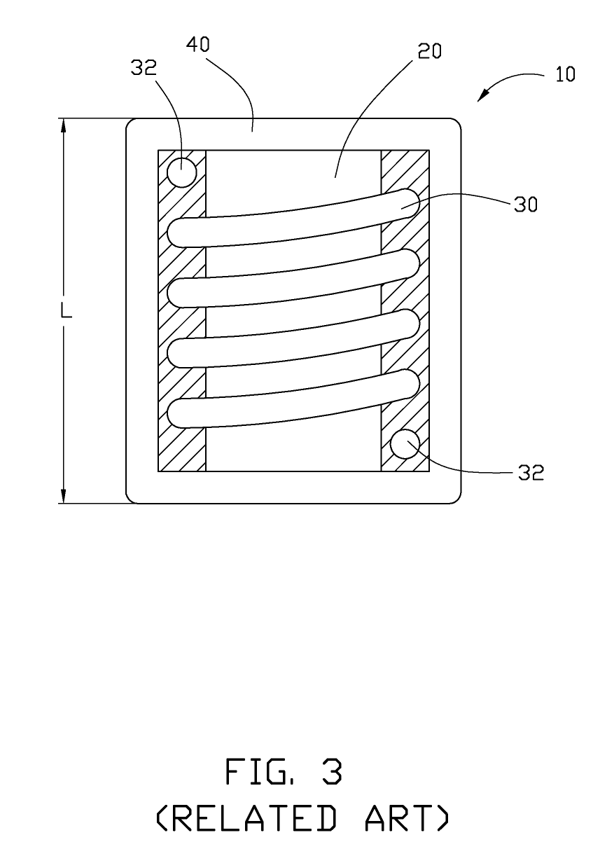

DCR=L/(S*C) (1)

where DCR is a direct current resistance of the conductor, L is the length of the conductor, S is a cross-sectional area of the conductor, and C is a conductance of the conductor. If the length and the conductance of the inductor coil 300 are substantially equal to a length and a conductance of the typical inductor coil 30 shown in FIG. 3, and a diameter of the ferromagnetic core 200 is equal to a diameter of the ferromagnetic core 20 of the typical inductor coil 30, then the cross-sectional area of the inductor coil 300 is greater than a cross-sectional area of the typical inductor coil 30. Therefore, according to equation (1), the DCR of the inductor coil 300 is less than the DCR of the typical inductor coil 30. Power loss is proportional to the DCR of a conductor. Therefore, the power loss of the inductor 100 is less than the power loss of the typical inductor 10. Thus, the inductor 100 is more efficient than the typical inductor 10.

In addition, because the inductor 100 employs a long flat conductor as the inductor coil 300, the inductor coil 300 overlaps one or more loops in a plane, and the inductor coil 300 is coated with varnish and/or wrapped with insulating tape, eddy current loss of the inductor coil 300 can be reduced by reducing the thickness of the inductor coil 300.

It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

1. An inductor comprising:
a columniform-shaped ferromagnetic core;
a long flat inductor coil comprising a plurality of concentric overlapping loops, wherein the plurality of overlapping loops are arranged in a plane, the inductor coil defines a through hole surrounded by an innermost loop of the plurality of overlapping loops; the innermost loop to fit around the ferromagnetic core, a first end of the inductor coil protrudes out along a tangent direction of an outermost loop of the plurality of overlapping loops, a second end of the inductor coil protrudes out from the innermost loop of the plurality of overlapping loops and is perpendicular to the first end of the inductor coil; and
a rectangular-shaped holder for holding the ferromagnetic core with the inductor coil, wherein the first and second ends of the inductor coil protrude out of the holder along an opening direction of the holder.

2. The inductor of claim 1, wherein the inductor coil is made of copper.

3. (canceled)

4. An inductor coil comprising:
a long flat conductor, wherein the long flat conductor is coiled to form a plurality of concentric overlapping loops around a center; the plurality of overlapping loops are arranged in a plane, a through hole is defined surrounded by an innermost loop of the plurality of overlapping loops; the innermost loop to fit around a columniform-shaped ferromagnetic core, a first end of the inductor coil protrudes out along a tangent direction of an outermost loop of the plurality of overlapping loops, a second end of the inductor coil protrudes out from the innermost loop of the plurality of overlapping loops and is perpendicular to the first end of the inductor coil.

5. The inductor coil of claim 4, wherein the conductor is made of copper.
